(19) United States
(12) Patent Application Publication
(10) Pub. No.: US 2013/0235622 A1
(43) Pub. Date: Sep. 12, 2013

(54) POWER SUPPLY DEVICE

(71) Applicants: Junichi Masuda, Toyokawa-shi (JP); Mikiyuki Aoki, Toyohashi-shi (JP); Taku Kimura, Kozakai-cho (JP); Takahiro Yokoya, Hichioji-shi (JP)

(72) Inventors: Junichi Masuda, Toyokawa-shi (JP); Mikiyuki Aoki, Toyohashi-shi (JP); Taku Kimura, Kozakai-cho (JP); Takahiro Yokoya, Hichioji-shi (JP)

(73) Assignee: Konica Minolta Business Technologies, Inc., Chiyoda-ku (JP)

(21) Appl. No.: 13/781,865

(22) Filed: Mar. 1, 2013

(30) Foreign Application Priority Data
Mar. 9, 2012 (JP) 2012-053842

(51) Int. Cl. H02M 3/335

(52) U.S. Cl. CPC H02M 3/33507
USPC 363/21.12

(57) ABSTRACT

A power supply device comprises: a rectifier circuit converting AC input voltage to DC; a smoothing capacitor connected to an output terminal of the rectifier circuit; a switching element turning on and off output from the smoothing capacitor to provide to a load; a switching controller controlling the switching of the switching element; a first signal input part generating a first signal for stopping the switching and keeping it stopped and inputting the first signal to the switching controller via a particular terminal thereof, when a trouble occurs on the power supply device; a detector detecting that the AC input voltage is a predetermined value or less; and a second signal input part generating a second signal for stopping the switching and keeping it stopped and inputting the second signal to the switching controller via the particular terminal, when the AC input voltage is the predetermined value or less.

This application claims priority under 35 U.S.C. §119 to Japanese Patent Application No. 2012-053842 filed on Mar. 9, 2012, the entire disclosure of which is Incorporated herein by reference In its entirety.

### BACKGROUND OF THE INVENTION

1. Field of the Invention

The present invention relates to a power supply device which supplies power to image forming apparatuses such as copiers, printers, and multifunctional machines, and other various devices.

2. Description of the Related Art

The following description sets forth the inventor's knowledge of related art and problems therein and should not be construed as an admission of knowledge in the prior art.

Generally, power supply devices supplying power to image forming apparatuses and other various devices are provided with: a rectifier circuit which converts commercial AC input voltage of 100V, to DC by rectification; a smoothing capacitor which is connected to an output terminal of the rectifier circuit; a switching element which turns on and off a signal output from the smoothing capacitor; and a switching controller which controls switching operations of the switching element. In order to provide appropriate voltage to a load, the switching element is provided with a step-down transformer which steps down voltage output from the smoothing capacitor.

Furthermore, most of the power supply devices are configured to monitor their own state for safety inspections, and they are therefore allowed to stop its operation when need, generate a signal for keeping the operation stopped, and input the signal to a switching controller.

To stop operation of an image forming apparatus or reset the state of an image forming apparatus, users may turn on its power supply device. In the perception of general users, when turning off the power supply device by shutting off or stepping down AC input voltage, the image forming apparatus having the power supply device stops its operation instantly.

However, if the power supply device is turned off while the image forming apparatus is operating under a light load, for example in energy-saving mode, the smoothing capacitor still holding enough charge continues providing power to the load, and as long as power is supplied, the energy-saving mode cannot be reset. After that, when the power supply device is turned on, the image forming apparatus starts its operation in energy-saving mode again instead of normal operation mode, which would not be a situation where users expect to continue their operation.

Japanese Unexamined Patent Publication No. 2006-166561 suggests a power supply device with latch protection functionality which achieves in the shortening of a unlatching period without consuming much power, by disconnecting a discharging resistor, which is connected to a terminal controlling power supply, from the ground under a proper load and connecting the discharging resistor to the ground under too much load.

Japanese Unexamined Patent Publication No. H10-014227 discloses a switching power supply device which is configured to stop its operation using a latch when externally receiving a signal indicating occurrence of a trouble. If being turned off after stopping operation using the latch, the power supply consumes much less power than conventional power supply devices in sleep mode by releasing the latch.

However, neither of the techniques in the above-introduced publications can be a perfect solution to the problem that if the power supply device is turned off while the image forming apparatus is operating under a light load, the smoothing capacitor still holding enough charge continues providing power to the load. Consequently, it has been long desired to provide a perfect power supply devices which can solve the problem without an additional circuit of a complex architecture.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

A first aspect of the present invention relates to a power supply device comprising:
a rectifier circuit which is configured to convert AC input voltage to DC by rectification;
a smoothing capacitor which is connected to an output terminal of the rectifier circuit;
a switching element which is configured to turn on and off output from the smoothing capacitor to provide to a load;
a switching controller which is configured to control the switching operation of the switching element;
a first stop signal input part which is configured to generate a first signal for stopping the switching operation of the switching element and keeping the switching operation stopped and input the first signal to the switching controller via a stopped state keeping terminal of the switching controller, when a trouble occurs on the power supply device;
a detector which is configured to detect that the AC input voltage is a predetermined value or less; and
a second stop signal input part which is configured to generate a second signal for stopping the switching operation of the switching element and keeping the switching operation stopped and input the second signal to the switching controller via the stopped state keeping terminal of the switching controller, when the detector detects that the AC input voltage is the predetermined value or less.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram illustrating how an AC power source, a power supply device, a power supply switch, and a load are connected to each other;

FIG. 2 illustrates a circuit of a power supply device which is commonly used;

FIG. 3 is a circuit diagram of a power supply device according to one embodiment of the present invention;

FIG. 4 is a time-sequence diagram illustrating the waveforms of voltage and signals output from primary components; and

FIG. 5 is a circuit diagram illustrating an example of an AC voltage monitoring circuit.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, an embodiment of the present invention will be described with reference to the accompanying drawings.

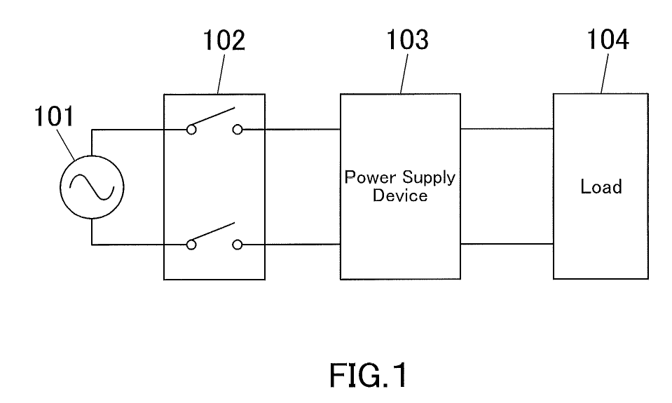

FIG. 1 is a block diagram illustrating how to connect an AC power source, a power supply device, a power supply switch, and a load to each other.

As illustrated herein, a power supply device 103 receives power from an AC power source 101 which turns on and off according to on a power supply switch 102. The power supply device 103 converts AC high voltage to DC low voltage (of 24V or 5V, for example) to provide it to a load 104 such as an image forming apparatus. The power supply switch 102 is turned on and off by users. As long as the power supply switch 102 is off, the power supply device 103 does not provide DC voltage to the load 104 without receiving power from the AC power source 101.

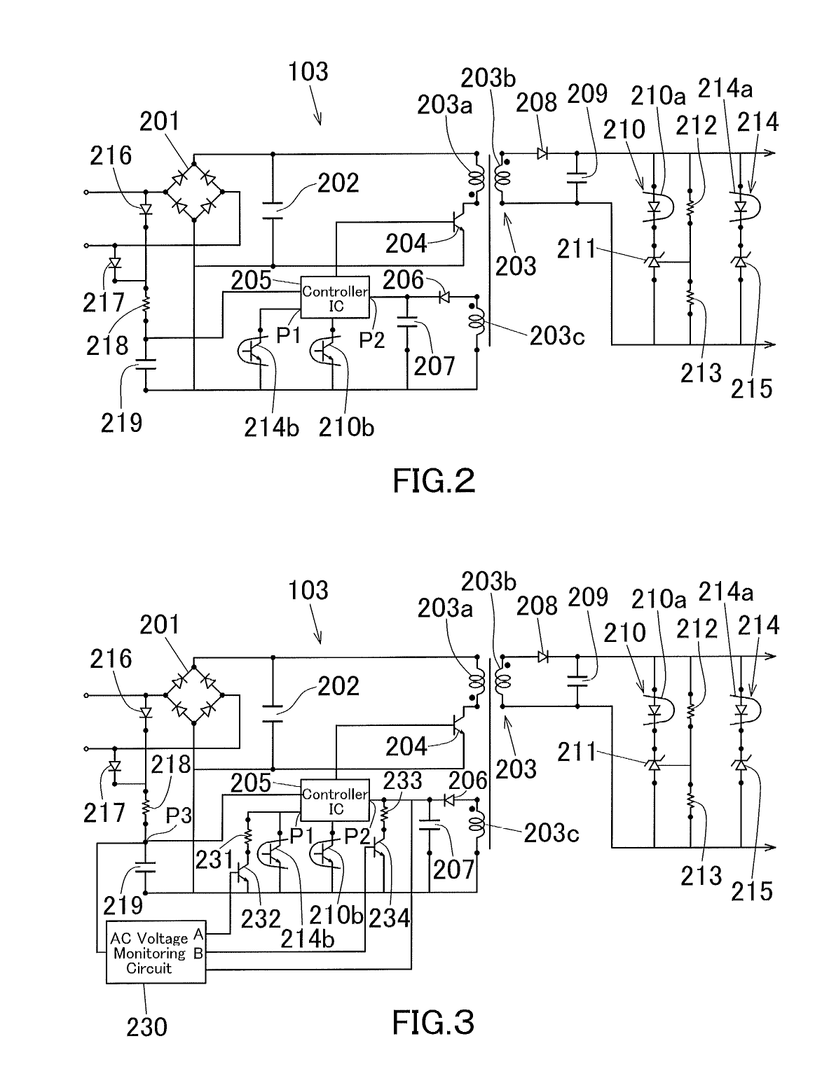

FIG. 2 illustrates one example of a circuit embedded in the power supply device 103 which is commonly used.

The power supply device 103 is provided with a diode bridge 201, i.e., a rectifier circuit which converts AC input voltage from the AC power source 101, to DC by full-wave rectification. Connected to an output terminal of the diode bridge 201 is a first smoothing capacitor 202 which smooths the rectified DC voltage obtained by the diode bridge 201.

Connected to an output terminal of the first smoothing capacitor 202 is a series circuit consisting of: a first winding 203a of a step-down transformer 203; and a switching FET 204, i.e., a switching element.

The switching FET 204 has a gate connected to a switching controller IC 205 which controls the on and off state of the switching FET 204.

Connected to the switching controller IC 205 are a power supply circuit composed of an auxiliary winding 203c of the step-down transformer 203, a diode 206, and a capacitor 207, so that the switching controller IC 205 can continue receiving power from the power supply circuit after the power supply device 103 is turned on. In contrast, when the power supply device 103 is turned on, the switching controller IC 205 starts receiving power from the AC power source 101 by way of: diodes 216 and 217 connected to the AC power source 101; a resistor 218; and a capacitor 219.

Further connected to the switching controller IC 205 are: a photo-sensitive element 210b of a photocoupler 210 which generates a control signal for control the duty cycle created by an on and off signal input to the switching FET 204; and a light-receiving element 214b of a photocoupler 214 which stops switching operation of the switching FET 204 by shutting off a control signal output from the switching controller IC 205 and generates an emergency signal (first signal) for immediately stopping operation of the power supply device 103, when a trouble occurs on the power supply device 103.

The step-down transformer 203 has a second winding 203b, whose output terminal is connected to a rectifier diode 208 and a second smoothing capacitor 209. Connected to an output terminal of the second smoothing capacitor 209 is a series circuit consisting of: a shunt regulator 211 and a light-emitting element 210a of a photocoupler 210, which maintains regular voltage to provide to the load 104. There are two voltage divider resistors 212 and 213 also connected to the output terminal of the second smoothing capacitor 209, and the shunt regulator 211 monitors voltages at these voltage divider resistors.

Connected to the output terminal of the second smoothing capacitor 209 is a series circuit consisting of a zener diode 215 and a light-emitting element 214a of the photocoupler 214, which detects an unusual rise of output voltage due to occurrence of a trouble on the power supply device 103.

Hereinafter, operation of the power supply device 103 of FIG. 2 will be described in details.

Being received by an input portion of the diode bridge 201, AC input voltage is rectified in full-wave by the diode bridge 201 then provided to the first smoothing capacitor 202. The first smoothing capacitor 202 holds enough charge to satisfy the conditions for instantaneous power failure when the load 104 is maximum. The rectified DC voltage is then smoothed by the smoothing capacitor 202. And the DC voltage of an effective value is input to the step-down transformer 203. Connected to the other end of the first winding 203a of the step-down transformer 203 is the switching FET 204, whose switching operation is controlled by the switching controller IC 205.

When the power supply device is turned on, the switching controller IC 205 starts its operation by receiving AC input voltage by way of the diodes 216 and 217. After the power supply device 103 is turned on, step-down AC voltage output from the auxiliary winding 203c of the step-down transformer 203 is converted to DC by the diode 206, smoothed by the capacitor 207, then provided to a power supply terminal P2 of the switching controller IC 205.

The switching controller IC 205 is further provided with a latch terminal P1 which is capable of stopping switching operation by inputting a predetermined stop signal to the switching controller IC 205 when a trouble occurs on the power supply device 103. The latch terminal PC also has a function to keep the switching operation stopped still after the power supply device 103 recovers from a trouble.

In order to start switching again, it is necessary to reset the switching controller IC 205 by shutting off the power to the switching controller IC 205.

The switching FET 204 performs switching operation by receiving a switching signal from the switching controller IC 205, causing an AC waveform at both ends of the first winding 203a of the step-down transformer 203. After the AC waveform is reduced by the second winding 203b of the step-down transformer 203, a DC voltage of 24V, for example, is generated by the rectifier diode 208 and the second smoothing capacitor 209.

By the shunt regulator 211, the DC voltage is monitored at the voltage divider resistors 212 and 213 and the light-emitting element 210a of the photocoupler 210 is controlled so as to maintain the DC voltage to a predetermined value. Based on the current value of the light-receiving element 210b of the photocoupler 210, the on-duty period of the switching FET 204 is adjusted by the switching controller IC 205.

In addition, there is a circuit which shuts off the power supply so that the load 104 would not receive a DC voltage of a predetermined value or more, when occurrence of a trouble on the power supply device 103 causes too much AC input voltage. The DC voltage is monitored by the zener diode 215. When the DC voltage is a predetermined value or more, the zener diode 215 turns on, allowing the light-emitting element 214a of the photocoupler 214 to start operation and allowing the light-receiving element 214b of the photocoupler 214 to set the latch terminal P1 of the switching controller IC 205 to on. And the power supply device 103 is therefore allowed to stop its operation safely. As described above, in this embodiment, the power supply device 103 has a circuit architecture including a first stop signal input part, in which when a trouble occurs on the power supply device 103, the zener diode 215 turns on, switching operation of the switching FET 204 is stopped by the light-emitting element 214a of the photocoupler 214, a first signal for keeping the switching operation stopped is generated by the light-receiving element 214b of the photocoupler 214 and input to the latch terminal P1 of the switching controller IC 205.

In the configurations of FIGS. 1 and 2, if the power supply switch 102 is turned off while the load 104 needs much current, the entire charge stored on the first smoothing capacitor 202 is discharged instantly, the power to the switching controller IC 205 is shut off, and switching operation of the switching FET 204 is stopped. And the load 104 is therefore not allowed to continue receiving DC voltage. On the other hand, if the power supply switch 102 is turned off by a user while the load 104 needs little current, for example while the image forming apparatus is in energy-saving mode, the entire charge stored on the first smoothing capacitor 202 may not be discharged instantly and partially remain thereon.

The first smoothing capacitor 202 still holding enough charge continues providing power to the switching controller IC 205, and switching operation of the switching FET 204 is not stopped. And the load 104 is therefore allowed to continue receiving DC voltage. Even when a user turns off the power supply switch 102, the power supply device 103 continues providing DC voltage to the load 104. Therefore, after that, when turning on the power supply switch 102, the user would not be in a situation where he/she expects to continue his/her operation.

FIG. 3 is a circuit diagram of the power supply device 103 according to one embodiment of the present invention.

In the power supply device 103, the resistor 218 and the capacitor 219 are connected to each other at a connection point P3 in a circuitry part for providing power to the switching controller IC 205 of the commonly-used power supply device 103 of FIG. 2, and there further is an AC voltage monitoring circuit 230 connected to the connection point P3. An output from an output terminal A of the AC voltage monitoring circuit 230 is input to the latch terminal P1 of the switching controller IC 205 by way of a transistor 232 and a resistor 231. Meanwhile, an output from an output terminal B of the AC voltage monitoring circuit 230 is input to the power supply terminal P2 of the switching controller IC 205 by way of a transistor 234 and a resistor 233.

The power supply device 103 of FIG. 3 has a circuit architecture identical with that of FIG. 2, except for the resistor 218, the capacitor 219, the AC voltage monitoring circuit 230, the transistor 232, the resistor 231, the transistor 234, and the transistor 233, and the detailed description thereof is hereby omitted for clarity.

The AC voltage monitoring circuit 230 is configured to output a single pulse signal for a predetermined period if the AC input voltage is a predetermined value or less or if the AC input voltage is more than a predetermined value. In other words, if the power supply switch 102 is turned off after being on, the voltage at the connection point P3 connecting the resistor 218 and capacitor 219 to each other, i.e., the AC input voltage, goes down to a predetermined value or less. Detecting this, the AC voltage monitoring circuit 230 outputs a “high” signal (second signal) from an output terminal A for a predetermined period. If the power supply switch 102 is turned on after being off, the AC input voltage rises to more than the predetermined value. Detecting this, the AC voltage monitoring circuit 230 outputs a “high” signal (release signal) for a predetermined period from an output terminal B.

As understood from the description above, in this embodiment, the power supply device 103 has a circuit architecture including: a second stop signal input part, in which if the AC voltage monitoring circuit 230 detects that the AC input voltage is a predetermined value or less, a second signal for stopping switching operation of the switching FET 204 and keeping the switching operation stopped is generated and input to the latch terminal P1 of the switching controller IC 205; and a release signal input part, in which if the AC voltage monitoring circuit 230 detects that the AC input voltage is more than a predetermined value after detecting that it is the predetermined value or less, a release signal for starting the switching operation again is generated and input to the switching controller IC 205.

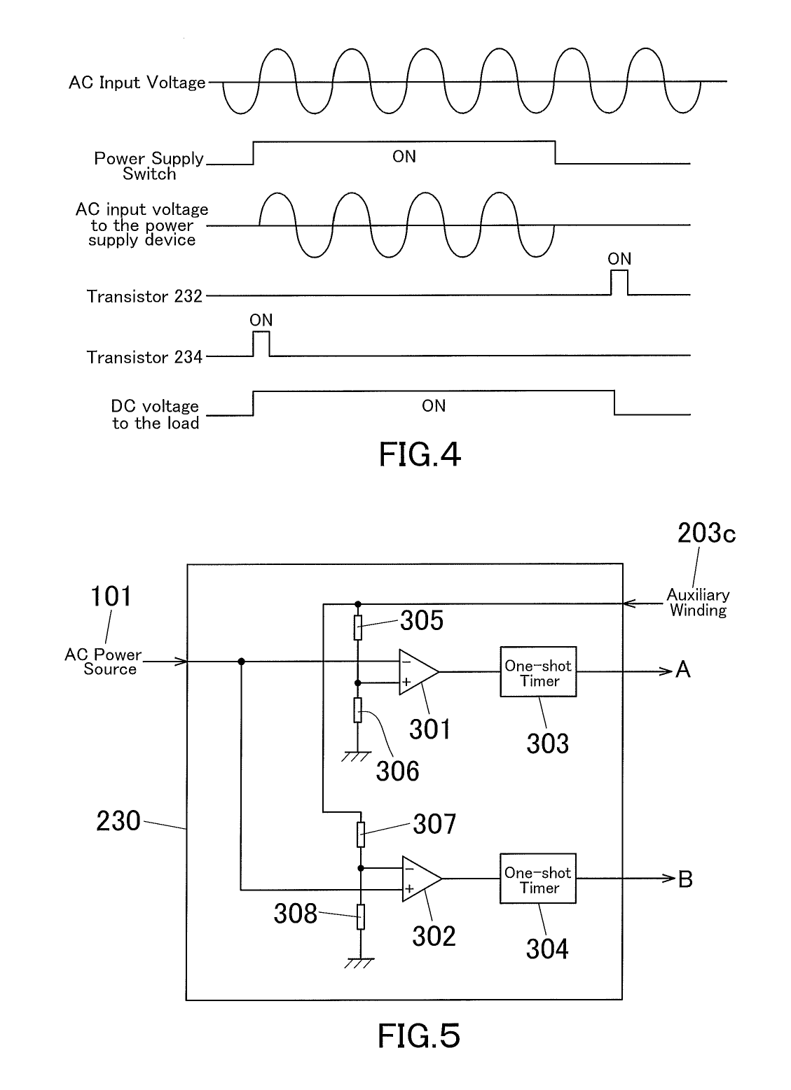

FIG. 4 is a time-sequence diagram of the waveforms of voltage and signals of primary components of the AC voltage monitoring circuit 230 from the power supply device 103 of FIG. 3.

If the power supply switch 102 is turned on by a user after being off without power from the AC power source 101, a “high” signal, i.e., a second signal is output from the output terminal B of the AC voltage monitoring circuit 230, and the transistor 234 turns on and keeps itself on for a predetermined period by receiving this signal. As soon as the transistor 234 turns on, the switching controller IC 205 is reset. After lapse of the predetermined period, the transistor 234 turns off by losing a “high” signal from the output terminal B of the AC voltage monitoring circuit 230, which allows the switching controller IC 250 to start operation again, and the power supply device 103 therefore starts providing DC voltage to the load 104.

If the power supply switch 102 is turned off after being off, a “high” signal, i.e., a first signal, is output from the output terminal A of the AC voltage monitoring circuit 230, and the transistor 232 turns on and keeps itself on for a predetermined period by receiving this signal. As soon as the transistor 232 turns on, the latch terminal P1 of the switching controller IC 205 is set to on, and the switching controller IC 205 is thereby prevented from operating. After that, if the transistor 232 turns off by losing a “high” signal from the output terminal A of the AC voltage monitoring circuit 230, the power supply device 103 does not start providing DC voltage to the load 104.

After that, when the power supply switch 102 is turned on, a “high” signal, i.e., a second signal, is output from the output terminal B of the AC voltage monitoring circuit 230 again, and the transistor 232 turns on and keeps itself on for a predetermined period by receiving this signal. As soon as the transistor 234 turns on, the switching controller IC 205 is reset, and the latch terminal P1 of the switching controller IC 205 is set to off so that the latch will be released. After that, the switching controller IC 250 is allowed to start operation again, and the power supply device 103 starts providing DC voltage to the load 104.

As described above, in this embodiment, when the AC input voltage is a predetermined value or less, a second signal is input to the latch terminal P1 of the switching controller IC 205 in order to stop switching operation of the switching FET 204 and keep it stopped, which is a result of taking advantage of the existing latch terminal P1 of the switching controller IC 205 which usually serves to stop switching operation of the switching FET 204 and keeps it stopped when a trouble occurs on the power supply device 103. As described above, when the power supply switch 102 is turned off, the power supply device 103 is allowed to stop its operation and keep it stopped properly by taking advantage of the existing latch terminal P1. It is an advantage that the power supply device 103 does not have to load an additional circuit of a complex architecture, but only that of a simple architecture which would not require much cost.

If the AC input voltage is more than a predetermined value after being the predetermined value or less; i.e., if the power supply switch 102 is turned on after being off, a release signal is input to the switching controller IC 205 to release the latch properly, allowing the switching FET 204 to start switching again.

It is properly detected that the AC voltage input via the diodes 216 and 217, upstream of the rectifier circuit 201, is a predetermined value or less and that the same is more than the predetermined value. Therefore, when the power supply switch 102 is turned off, the power supply device 103 is allowed to stop its operation and keep it stopped properly, and after that, when the power supply switch is turned on, the power supply device 103 is allowed to start its operation again properly.

FIG. 5 is a circuit diagram illustrating an example of the AC voltage monitoring circuit 230.

The AC voltage monitoring circuit 230 is provided with: two comparators 301 and 302 with both a positive and negative terminal receiving the voltage at the connection point P3 connecting the resistor 218 and the capacitor 219 to each other; two resistors 305 and 306 dividing the voltage output from the auxiliary winding 203c to provide to the switching controller IC 205; two resistors 307 and 308 with a resistance value identical with that of the resistors 305 and 306, also dividing the voltage output from the auxiliary winding 203c to provide to the switching controller IC 205; and two one-shot timers 303 and 304 receiving a signal output from the comparators 301 and 302, respectively, and outputting a pulse signal for a predetermined period.

The voltage divider point between the resistors 305 and 306 is connected to the positive terminal of the comparator 301; the voltage divider point between the resistors 307 and 308 is connected to the negative terminal of the comparator 302.

In the AC voltage monitoring circuit 230 of FIG. 5, when the power supply switch 102 is turned on, the voltage at the positive terminal of the comparator 302 starts rising and eventually reaches to more than the voltage at the voltage divider point between the resistors 307 and 308, making the comparator 302 turn on. And the one-shot timer 304 is therefore allowed to output a one-shot pulse signal (release signal) via the output terminal B.

When the power supply switch 102 is turned off, the voltage at the negative terminal of the comparator 301 starts going down and eventually reaches to the voltage at the voltage divider point between the resistors 305 and 306 or less, making the comparator 301 turn on. And the one-shot timer 303 is therefore allowed to output a one-shot pulse signal (second signal) via the output terminal A.

The present invention having been described above may be applied to the following modes.

[1] A power supply device comprising:
a rectifier circuit which is configured to convert AC input voltage to DC by rectification;
a smoothing capacitor which is connected to an output terminal of the rectifier circuit;
a switching element which is configured to turn on and off output from the smoothing capacitor to provide to a load;
a switching controller which is configured to control the switching operation of the switching element;
a first stop signal input part which is configured to generate a first signal for stopping the switching operation of the switching element and keeping the switching operation stopped and input the first signal to the switching controller via a stopped state keeping terminal of the switching controller, when a trouble occurs on the power supply device;
a detector which is configured to detect that the AC input voltage is a predetermined value or less; and
a second stop signal input part which is configured to generate a second signal for stopping the switching operation of the switching element and keeping the switching operation stopped and input the second signal to the switching controller via the stopped state keeping terminal of the switching controller, when the detector detects that the AC input voltage is the predetermined value or less.

[2] The power supply device as recited in the aforementioned mode [1], further comprising a release signal input part which is configured to generate a release signal for starting the switching operation of the switching element again and input the release signal to the switching controller, when the detector detects that the AC input voltage is more than the predetermined value after being the predetermined value or less.

[3] The power supply device as recited in the aforementioned mode [1], wherein the detector detects that the AC input voltage upstream of the rectifier circuit is the predetermined value or less.

[4] The power supply devices as recited in the aforementioned mode [2], wherein the detector detects that that the AC input voltage upstream of the rectifier circuit is the predetermined value or less and that the AC input voltage upstream of the rectifier circuit is more than the predetermined value.

According to the invention as described in the aforementioned mode [1], when a trouble occurs on the power supply device, a first signal for stopping switching operation of the switching element and keeping it stopped is inputted to the stop state keeping terminal of the switching controller; when the detector detects that the AC input voltage is a predetermined value or less, a second signal, instead of the first signal, is inputted to the stop state keeping terminal of the switching controller. By receiving this second signal, the switching controller does not allow the switching element to continue its operation and keeps the switching operation stopped. In other words, when the power supply switch is turned off, the power supply device is allowed to stop its operation and keep it stopped properly by taking advantage of the existing terminal, i.e., by inputting a second signal to the stop state keeping terminal of the switching controller. It is an advantage that the power supply device does not have to load an additional circuit of a complex architecture, but that of a simple architecture to generate a second signal when the detector detects the AC input voltage is a predetermined value or less, which would not require much cost.

According to the invention in the aforementioned mode [2], if the detector detects that the AC input voltage is more than a predetermined value after being the predetermined value or less; i.e., if the power supply switch 102 is turned on after being off, a release signal is input to the switching controller to release the latch, allowing the switching element to start switching again.

According to the inventions as described in the aforementioned modes [3] and [4], the detector detects that the AC input voltage upstream of the rectifier circuit is the predetermined value or less and that the AC input voltage upstream of the rectifier circuit is more than the predetermined value. Therefore, when the power supply switch is turned off, the power supply device is allowed to stop its operation and keep it stopped properly, and after that, when the power supply switch is turned on, the power supply device is allowed to start its operation again properly.

While the present invention may be embodied in many different forms, a number of illustrative embodiments are described herein with the understanding that the present disclosure is to be considered as providing examples of the principles of the invention and such examples are not Intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A power supply device comprising:
a rectifier circuit which is configured to convert AC input voltage to DC by rectification;
a smoothing capacitor which is connected to an output terminal of the rectifier circuit;
a switching element which is configured to turn on and off output from the smoothing capacitor to provide to a load;
a switching controller which is configured to control the switching operation of the switching element;
a first stop signal input part which is configured to generate a first signal for stopping the switching operation of the switching element and keeping the switching operation stopped and input the first signal to the switching controller via a stopped state keeping terminal of the switching controller, when a trouble occurs on the power supply device;
a detector which is configured to detect that the AC input voltage is a predetermined value or less; and
a second stop signal input part which is configured to generate a second signal for stopping the switching operation of the switching element and keeping the switching operation stopped and input the second signal to the switching controller via the stopped state keeping terminal of the switching controller, when the detector detects that the AC input voltage is the predetermined value or less.

2. The power supply device as recited in claim 1, further comprising a release signal input part which is configured to generate a release signal for starting the switching operation of the switching element again and input the release signal to the switching controller, when the detector detects that the AC input voltage is more than the predetermined value after being the predetermined value or less.

3. The power supply device as recited in claim 1, wherein the detector detects that the AC input voltage upstream of the rectifier circuit is the predetermined value or less.

4. The power supply devices as recited in claim 2, wherein the detector detects that that the AC input voltage upstream of the rectifier circuit is the predetermined value or less and that the AC input voltage upstream of the rectifier circuit is more than the predetermined value.
